(19) United States
(12) Patent Application Publication
(10) Pub. No.: US 2012/0085604 A1
(43) Pub. Date: Apr. 12, 2012

(54) PROCESS FOR MANUFACTURING BRAKE LININGS, MANUFACTURING MOULDS AND PRODUCT OBTAINED

(75) Inventor: JACIR DALLEGRAVE, CAXIAS DO DUL (BR)

(73) Assignee: DUROLINE S.A., CAXIAS DO SUL (BR)

(21) Appl. No.: 13/326,299

(22) Filed: Dec. 14, 2011

Related U.S. Application Data
(63) Continuation of application No. PCT/BR2010/000132, filed on Apr. 19, 2010.

(30) Foreign Application Priority Data
Jun. 19, 2009 (BR) PI 0903680-6

(51) Int. Cl. F16D 65/04; B29C 51/42; B28B 11/08

(52) U.S. Cl. 188/234; 264/293; 425/384

(57) ABSTRACT

A process for manufacturing brake linings that comprises the stage of cold heating of the friction material and compaction by using a punch with a surface having sinuosity (10) that presses the friction material (100) forming undulations on the surface (110), and the stage of heat pre-molding of the friction material at a temperature lower than that of the resin polymerization for better shaping of the pre-mold, because the resin adheres in a form of a thin layer (film) onto the entire surface which defines a better shape of the pre-mold and, also, provides the material with the heat closer to that of polymerization, which ensures a better quality for the product, and then, the stage of heat molding of the pre-formed friction material and compaction by using a curve-like punch (20). Additionally, this invention discloses an obtained product that comprises friction material with bigger or smaller interspersed oriented density areas.

### CROSS-REFERENCE TO RELATED APPLICATIONS

This Application is a CONTINUATION application claiming the benefit of priority of the co-pending International Patent Application No. PCT/BR2010/000132 with an international filing date of 19 Apr. 2010 that designated the United States, which claims the benefit of priority of Federal Republic of Brazil Patent Application No. PI 0903680-6, filed 19 Jun. 2009, the entire disclosures of all Applications are expressly incorporated by reference in their entirety herein.

### BACKGROUND OF THE INVENTION

1. Field of the Invention

This invention refers to a process for the manufacture of brake linings, manufacturing molds, and a product obtained. More specifically, this inventions comprises a process for the manufacture of brake linings, preferably, for heavy vehicles, which increases the performance of the friction level or braking power, wears out the brake lining slower, and reduces the noise level through a physical-chemical process and specific molds.

2. Description of Related Art

Brake pads and linings are usually manufactured by using a compound of synthetic fibers, metals, and resin with a higher or lower degree of hardness. The harder and the more resistant to the friction they are, the more efficient their performance is, but, at the same time, the faster the discs and drums wear out. Besides, materials with a higher degree of hardness have better resistance to higher temperatures. On the contrary, brake pads or linings with a lower degree of hardness brake better even when they are cold, but are too sensitive to increasing temperatures, lose efficiency when used continuously, and wear out fast. Therefore, it is necessary to find a balance between the hardness and the composition of the material for safe breaking under any conditions.

Overheated brake linings undergo a phenomenon known as fade. Starting from a certain temperature, the lining becomes “vitrified” reducing severely its coefficient of friction, and requiring a driver to press harder on the brake pedal in order to exercise appropriate control over the vehicle. Using good quality materials and avoiding abrupt and continuous braking of the vehicle may prevent the fade.

As a result, the essential characteristics of brake linings have to be as follows: resistance to brake fade; recovery—the ability of brake linings, during cooling, to quickly recover the original friction when subjected to high temperatures; inexistence of hidden fade, that is, during the period of recovery or cooling, the coefficient of friction starts returning to normal, and, suddenly, without warning, the brakes are return to the brake fade condition; sensitivity to speed, that is, the coefficient of friction cannot vary abruptly when the brake linings are subjected to speed variations; stability—keeping the coefficient of friction and the same braking power during the entire useful life of brake linings

The patent application PI9206126 discloses a friction lining for brake systems, which contains an asbestos-free friction element and an abrasive element consisting of abrasive material with a thermal rigid adhesive based on natural or synthetic resin; an abrasive element is incorporated into the element of friction which, as the friction lining keeps wearing out, allows the frictional properties of the surface that exerts pressure on the lining, to be restored from time to time.

The invention patent application PI9508564 discloses friction linings for drum brakes or for monoblock brake pads wherein the friction linings and the support element are made in conjunction by molding only one kind of material with the rear part of the friction lining having a stainless insert and resistant to temperatures above 200° C., said insert containing a surface which is visible from the outside of the lining and suitable to act as a means of carrying undeletable information.

The utility model application MU7502802 discloses an improved brake lining for heavy and light vehicles comprising a body that contains on its inner curvature a resistant net incorporated into adhered fibers, said net being made of carbon fiber or the like whose function is to reinforce the part, mainly, when it is at the end of its useful life.

Therefore, the technical literature describes processes for manufacturing brake linings and obtained products whose goal is to raise the performance of the friction level and cause less wear by using inserts or incorporating nets in order to increase the useful life of said brake linings.

However, the prior art neither discloses nor suggests a physical chemical process with differences in the oriented density, providing a product with a longer useful life, a smaller braking effort, less wear of the brake drum, and a noise reduction, said process for manufacturing brake linings, manufacturing moulds, and a product obtained being disclosed and claimed herein.

### BRIEF SUMMARY OF THE INVENTION

In general, this invention refers to a process for manufacturing brake linings that comprises the following stages: heat pre-molding of the friction material at a temperature lower than that of resin polymerization for better formatting of the pre-mold because the resin adheres in the form of a thin layer (film) onto the entire surface which defines a better shape of the pre-form and, also, provides the material with the amount of heat close to that of the polymerization process, which will raise the quality of the product; cold molding of the friction material and compaction by using a punch with a surface with sinuosity that presses the friction material forming waves on the surface; and heat molding of the pre-formed friction material and compaction by using a curve-like punch.

Furthermore, this invention refers to manufacturing molds that include a cold mold having an upper punch with a surface that includes a profile fitted with a small concavity having a continuous surface fitted with concave curves followed by convex curves, and a heat mold having an upper punch with a surface having a concavity.

Additionally, this invention discloses an obtained product that comprises a friction material with larger or smaller interspersed oriented density areas.

This invention is characterized by a process for manufacturing brake linings, which raises the performance of the friction level or braking power and causes less wear in the brake lining through a physical chemical process.

This invention is characterized by a brake lining with different densities of material generated from heat pre-molding, heat and cold molding by means of specific molds.

This invention is characterized by a brake lining with a reduced noise level due to the resonance reduction.

Additionally, this invention is characterized by a brake lining with a longer useful life, higher performance of the friction level when compared to the prior art brake linings.

### BRIEF DESCRIPTION OF THE DRAWINGS

FIG. 1 shows the cold molding, FIG. 1A demonstrating the wavy punch positioned in the upper portion of the mold wherein the friction material is placed, and

FIG. 1B demonstrating the punch pressed against the friction material in order to compact and settle different quantities of material along the mold.

FIG. 2 shows the heat molding, FIG. 2A demonstrating the curve-like punch positioned in the upper portion of the mold wherein the pre-molded friction material is,

FIG. 2B demonstrating the curve-like punch pressed against the pre-molded friction material that absorbs the transference of heat and starts the resin polymerization process, conforming a part with variable compaction in accordance with the peaks and depressions of the pre-molded material, and FIG. 2C demonstrating the friction material molded in a rigid and thermo-fixed part.

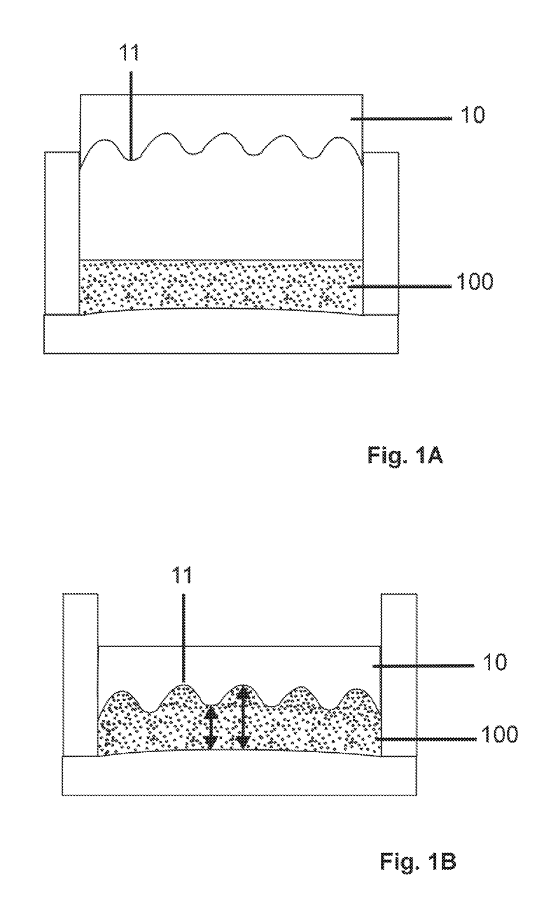

### DETAILED DESCRIPTION OF THE INVENTION

The process for manufacturing brake linings, subject matter hereof, comprises such physical chemical stages as cold and heat molding with variable and oriented compaction providing a product with a surface having different densities, which ensures a longer useful life and a better level of friction.

The process for manufacturing brake linings comprises the following stages:

a) cold molding of the friction material and compaction by using a punch with a surface having sinuosity (10) that presses the friction material (100) forming undulations on the surface (110). The heat pre-molding for better shaping of the pre-mold, the cold molding allows settling different quantities of the friction material longitudinally due to the concavities and convexities of the punch (10);
b) heat molding of the pre-formed friction material and compaction by using a curve-like punch (20).

The friction material (100) suffers pressure from the curve-like upper punch (20) with the compaction of the undulations formed in the cold molding, and, resulting polymerization of the resin of the friction material (100). A variable compaction is caused in the heat molding, which is oriented in accordance with the peaks and depressions of the previously cold-molded surface.

The product obtained comprises a friction material that undergoes a physical chemical process, providing smaller and larger interspersed oriented density areas.

In another embodiment, the process for manufacturing brake linings comprises the following stages:

a) cold molding of a first layer of the friction material (100) and compaction by using a punch with a surface having sinuosity (10) that presses the friction material (100), forming undulations (110) on the surface;
b) heat pre-molding of a second layer of the friction material placed on the first layer by using a punch with a surface having sinuosity (10) that presses the second layer of the friction material on the upper surface forming undulations (110);
c) heat molding of the first and second layer of the pre-formed friction material and compaction by using a curve-like punch (20).

The friction material (100) suffers pressure from the upper curve-like punch (20) with the compaction of the undulations (110) and resulting polymerization of the resin of the friction material (100).

In another embodiment, the obtained product comprises two layers, a first layer having smaller and larger interspersed density areas, and a second layer, placed on the first layer by means of thermal fusion, said second layer having smaller and larger interspersed density areas.

In this embodiment, the effect caused by the difference in the density of the friction material is increased, the first layer being intended for the area of the brake lining that serves as ballast and has to have a bigger mechanical resistance than braking, and the second layer placed on the first layer with longer durability than the anchoring resistance.

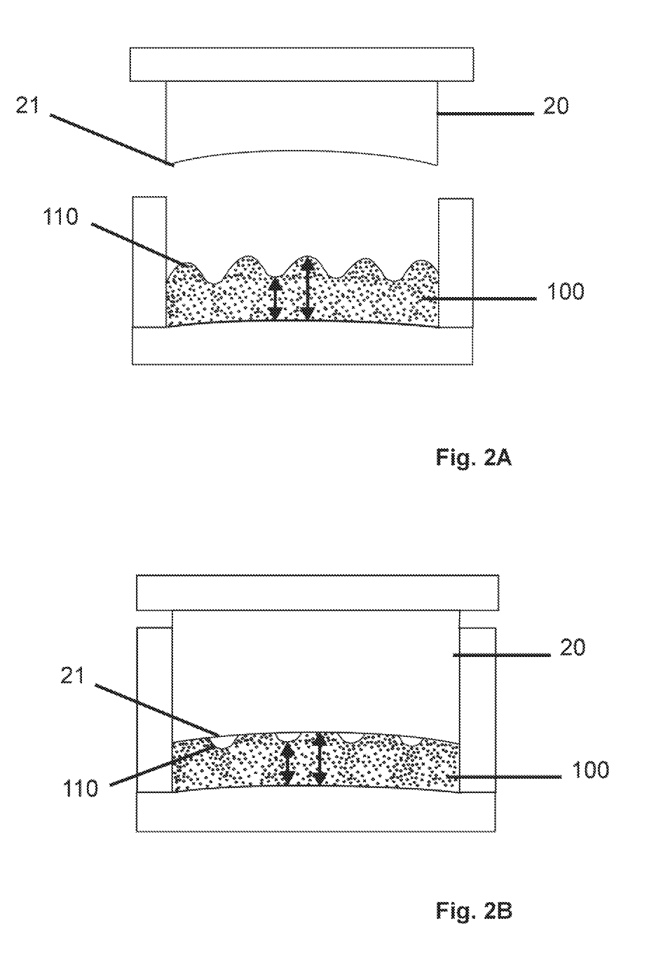

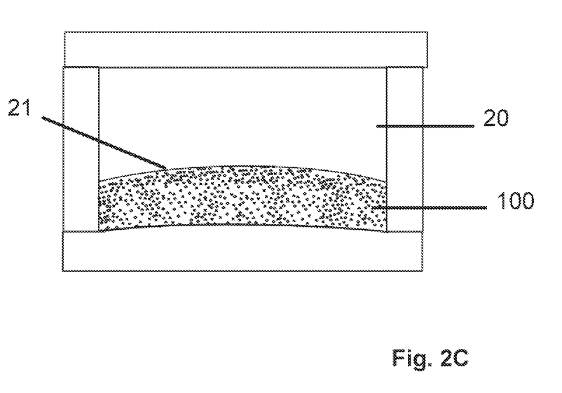

As shown in FIG. 2B, the vertical lines that show a bigger quantity of the material will have bigger compaction and the vertical lines that show a smaller quantity of the material will have smaller compaction, triggering a process of variable compaction on the surface of the friction material for brake linings.

Thus, the density will be bigger at the points having a bigger quantity of the material due to the peak recorded by the punch, and the density will be smaller at the points with a smaller quantity of the material due to the depression recorded by the punch.

The molds for manufacturing brake linings by using the process hereof comprise a cold mold and a hot mold.

The cold mold has an upper punch (10) with a surface that includes a profile having a small concavity with a continuous surface having concave curves followed by convex curves (11).

The hot mold has an upper punch (20) with a surface with a concavity (21).

When compared to the prior art brake linings having the same density all over the surface of the friction material, the brake linings obtained through the process, subject matter hereof, with bigger an smaller densities in an oriented manner.

Studies reveal that the surface of the friction material of the brake lining subjected to the heat generated by the braking affects the adhesiveness of the resin on the prior art brake linings meanwhile the brake lining, subject matter hereof, the brake lining is affected more in the less dense region and in a decreasing manner.

As the braking process continues, the adhesiveness of the resin is progressively affected in the prior art brake linings, meanwhile the brake lining, subject matter hereof, is decreasingly affected towards the smaller density region.

Even when the friction material is totally affected in the prior art brake linings, the vertical columns with a bigger density in the brake linings subject matter hereof ensure the continuity of the friction material, the friction components still exercising the braking process. Therefore, in addition to increasing their useful life, the braking power is also increased when compared to the prior art braking linings.

What is claimed is:

1. Process for manufacturing brake linings comprising the following stages:
a) Cold molding of the friction material and compaction by using a punch with a surface having sinuosity (10) that presses the friction material (100), forming undulations on the surface (110);
b) Heat pre-molding and heat molding of the pre-formed friction material and compaction by using a curve-like punch (20).

2. Product obtained in accordance with the process as claimed in 01 comprising friction material with smaller and larger interspersed oriented areas.

3. Process for manufacturing brake linings comprising the following stages:
a) Cold molding of a first layer of the friction material (100) and compaction by using a punch with a surface having sinuosity (10) that presses the friction material (100), forming undulations (110) on the surface;
b) Heat pre-molding of a second layer of the friction material placed on the first layer by using a punch with a surface having sinuosity (10) that presses the second layer of the material of friction on the upper surface, forming undulations (110);
c) Heat molding of the first and second layer of the pre-formed friction material and compaction by using a curve-like punch (20).

4. Product obtained in accordance with the process as claimed in 2 comprising two layers, a first layer having bigger and smaller interspersed density areas, and a second layer, placed on the first layer through thermal fusion, having bigger and smaller interspersed areas.

5. Molds for manufacturing brake linings comprising a cold mold that has an upper punch (10) with a surface that includes a profile having a small concavity with a continuous surface of concave curves followed by convex curves (11), a heat pre-mold, and a heat mold that has an upper punch (20) having a surface with a concavity (21).
